(19) United States
(12) Patent Application Publication
(10) Pub. No.: US 2025/0337671 A1
(43) Pub. Date: Oct. 30, 2025

(54) DATA TRANSMISSION METHOD AND APPARATUS, ELECTRONIC DEVICE, AND STORAGE MEDIUM

(71) Applicant: DOUYIN VISION CO., LTD., Shijingshan District, Beijing (CN)

(72) Inventors: Haiping WANG, Beijing (CN); Chaojun LI, Beijing (CN)

(21) Appl. No.: 18/998,368

(22) PCT Filed: Nov. 21, 2023
(86) PCT No.: PCT/CN2023/132903

§ 371 Date: Jan. 24, 2025

(30) Foreign Application Priority Data
Nov. 25, 2022 (CN) 202211489158.0

(51) Int. Cl. H04L 43/0829; H04L 1/08

(52) U.S. Cl. CPC H04L 43/0829; H04L 1/08

(57) ABSTRACT

The present disclosure relates to a data transmission method and apparatus, an electronic device, and a storage medium. The method includes: obtaining the size of a present data block and a historical packet loss rate of historical data blocks, the present data block comprising at least one data packet; based on the size of the present data block and the historical packet loss rate, determining a present packet loss detection threshold for the present data block; when on the basis of a number of first received data packets of the present data block it is determined that the present packet loss detection threshold is satisfied, performing packet loss detection on the present data block, and determining a first not-arrived data packet of the present data block; and obtaining the first not-arrived data packet so as to obtain a data packet of the present data block.

The present application is based on and claims the priority to the Chinese patent application No. 202211489158.0 filed on Nov. 25, 2022, the disclosure of which is incorporated by reference herein in its entirety.

### TECHNICAL FIELD

The present disclosure relates to the technical field of communication, and specifically to a data transmission method and apparatus, an electronic device, and a storage medium.

### BACKGROUND

Multiplex transmission technology, where data is downloaded from a plurality of servers by establishing a plurality of transmission connections, enables full use of heterogeneous uplink resources, and also enables a normal transmission capability to be maintained when a single connection is blocked, so that the multiplex transmission technology has a good prospect of application, and is currently widely used in streaming media services such as file download, short video, live streaming (or live broadcasting, or live), or the like.

### SUMMARY

Some embodiments of the present disclosure provide a data transmission method and apparatus, an electronic device, and a storage medium, so as to solve the problem of recovery in packet loss.

According to a first aspect, some embodiments of the present disclosure provide a data transmission method, comprising:
obtaining a size of a current data block and a historical packet loss rate of a historical data block, the current data block comprising at least one data packet;
determining a current packet loss detection threshold for the current data block based on the size of the current data block and the historical packet loss rate;
when determining, based on a number of first received data packets of the current data block, that the current packet loss detection threshold is satisfied, performing packet loss detection on the current data block to determine a first not-arrived data packets of the current data block; and
obtaining the first not-arrived data packets to obtain the data packets of the current data block.

According to a second aspect, some embodiments of the present disclosure further provide a data transmission apparatus, comprising:
a first obtaining module configured to obtain a size of a current data block and a historical packet loss rate of a historical data block, the current data block comprising at least one data packet;
a first determining module configured to determine a current packet loss detection threshold for the current data block based on the size of the current data block and the historical packet loss rate;
a second determining module configured to when determining, based on a number of first received data packets of the current data block, that the current packet loss detection threshold is satisfied, perform packet loss detection on the current data block to determine a first not-arrived data packets of the current data block; and
a second obtaining module configured to obtain the first not-arrived data packets to obtain the data packets of the current data block.

According to a third aspect, some embodiments of the present disclosure provide an electronic device, comprising: a memory and a processor, wherein the memory and the processor is communicatively connected with one another, the memory has computer instructions stored therein, and the processor, by executing the computer instructions, performs the data transmission method according to the first aspect or any of the implementations of the first aspect.

According to a fourth aspect, some embodiments of the present disclosure provide a computer-readable storage medium having stored thereon computer instructions for causing a computer to perform the data transmission method according to the first aspect or any of the implementations of the first aspect.

### BRIEF DESCRIPTION OF THE DRAWINGS

In order to more clearly illustrate technical solutions in the DETAILED DESCRIPTION or the prior art of the present disclosure, the drawings to be used in the DETAILED DESCRIPTION or the prior art will be briefly described below, and it is apparent that the drawings in the following description are some implementations of the present disclosure, and for one of ordinary skill in the art, other drawings can be obtained according to these drawings without paying creative labor.

FIG. 1 is a flow diagram of a data transmission method according to some embodiments of the present disclosure;

FIG. 2 is a flow diagram of a data transmission method according to some embodiments of the present disclosure;

FIG. 3 is a flow diagram of a data transmission method according to some embodiments of the present disclosure;

FIG. 4 is a flow diagram of a data transmission method according to some embodiments of the present disclosure;

FIG. 5 is a structural block diagram of a data transmission apparatus according to some embodiments of the present disclosure;

FIG. 6 is a schematic hardware structure diagram of an electronic device according to some embodiments of the present disclosure.

### DETAILED DESCRIPTION

To make the objectives, technical solutions and advantages of some embodiments of the present disclosure more apparent, the technical solutions in some embodiments of the present disclosure will be clearly and completely described below in conjunction with the accompanying drawings in some embodiments of the present disclosure, and it is apparent that the described embodiments are some of the embodiments of the present disclosure, rather than all of them. All other embodiments, which can be derived by those skilled in the art based on the embodiments in the present disclosure, without making creative labor, shall fall within the scope of protection of the present disclosure.

Multiplex transmission technology, where data is downloaded from a plurality of servers by establishing a plurality of transmission connections, enables full use of heterogeneous uplink resources, and also enables a normal transmission capability to be maintained when a single connection is blocked, so that the multiplex transmission technology has a good prospect of application, and is currently widely used in streaming media services such as file download, short video, live streaming, or the like. Generally, the streaming media service has a strict requirement for a transmission time of a data block, for example, the short video service has a requirement that a downloading time of a span of continuous data blocks should not exceed a remaining cache time, otherwise, lags may occur; and the live streaming service has a stricter requirement that a transmission time of a data block is in milliseconds. In a transmission process of a data block, if packet loss occurs without timely recovery, lags and degradation in image quality will be caused by the data block.

In packet loss retransmission detection, time-driven retransmission and acknowledge character (ACK for short)-driven retransmission are generally adopted. Specifically, the time-driven retransmission is that a timer is set by a sender when sending data, and if an acknowledge character of the data still has not been received when the timer times out, corresponding timeout and data retransmission will be triggered, wherein a timeout retransmission time is generally set to be 1 to 2 times a round trip time for a single connection, or estimated according to network changes. The time-driven retransmission is inefficient in recovery of data packets, and especially when there is a large delay in a path where packet loss occurs, the timeout retransmission time often exceeds a transmission time requirement for a data block, resulting in an excessive transmission time of the data block. The ACK-driven retransmission is that retransmission is triggered by a sender based on an acknowledge character of a receiver, rather than the timeout of the retransmission timer. If data packets do not arrive continuously, possible packet loss of the last one indicted by ACK is indicated, and if the sender receives the same ACK 3 times continuously, the data packet is retransmitted, wherein sending of only one data packet can be recovered once. A selective acknowledge character (SACK for short), which is an extension of the ACK, can support recovery of a plurality of data packets. Compared with the timeout-triggered retransmission mechanism, this retransmission mechanism is more efficient, but in essence, the sender needs to rely on receiving enough acknowledge messages for retransmission, and if the sent ACK is lost, transmission of the data block will be blocked by the data packet, so that the delay requirement of data block transmission cannot be satisfied.

It follows that, the above two packet loss retransmission mechanisms both are difficult in satisfying the streaming media application with a strict time limit requirement for data block transmission. Based on this, a data transmission method provided in some embodiments of the present disclosure is based on data packet-driven packet loss detection and retransmission mechanism; and by taking the data packet as a driving time, determining whether packet loss occurs and performing retransmission in time, it does not need to wait for the timeout trigger or the acknowledge message. Therefore, less packet loss recovery time and data block transmission time can be achieved, so that this method can be applied to a service having a time limit requirement for data block transmission, such as short video, live streaming, or the like.

According to some embodiments of the present disclosure, there is provided a data transmission method embodiment, and it should be noted that the steps illustrated in the flow diagram of the accompanying drawings may be performed in a computer system such as a set of computer-executable instructions, and that while a logical order is illustrated in the flow diagram, in some cases, the steps illustrated or described may be performed in an order different from the order here.

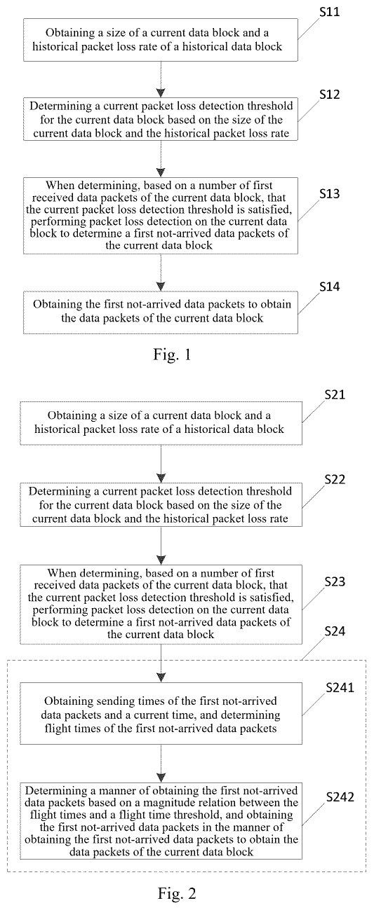

In this embodiment, a data transmission method is provided, which may be used in an electronic device, such as a mobile terminal, a computer, or the like; FIG. 1 is a flow diagram of a data transmission method according to some embodiments of the present disclosure, as shown in FIG. 1, comprising the following steps:
S11, obtaining a size of a current data block and a historical packet loss rate of a historical data block.

The current data block comprises at least one data packet.

The data block includes, but is not limited to, a video frame, an audio frame, etc., and detection is performed with a data block as a unit in this embodiment, and each data block can be independently delivered to an upper layer application for processing. Therefore, the detection with a data block as a unit enables packet loss to be found in time. The size of the current data block is determined according to actual service requirements, without any limitation on a specific value thereof herein.

The historical data block, which is a data block before the current data block, may be one data block, two data blocks, or a plurality of data blocks, without any limitation on a specific number thereof herein. The historical packet loss rate of the historical data block is a ratio of a number of lost data packets to a total number of data packets in the historical data block; each time a historical data block is received, the lost data packets are counted, so as to obtain the historical packet loss rates of respective historical data blocks.
S12, determining a current packet loss detection threshold for the current data block based on the size of the current data block and the historical packet loss rate.

By using a product of the historical packet loss rate and the size of the current data block, a number of lost packets of the current data block is predicted, which is taken as the current packet loss detection threshold; or, by subtracting the above product from the size of the current data block, a number of receivable data packets is determined, which is taken as the current packet loss detection threshold.
S13, when determining, based on a number of first received data packets of the current data block, that the current packet loss detection threshold is satisfied, performing packet loss detection on the current data block to determine a first not-arrived data packets of the current data block.

If the current packet loss detection threshold is represented by using the number of the lost packets, the number of the first received data packets is counted, and then, in combination with the size of the current data block, a number of the first not-arrived data packets is determined, and if the number of the first not-arrived data packets is equal to the current packet loss detection threshold, the packet loss detection on the current data block is triggered; and if the current packet loss threshold is represented by using the number of the received data packets, when the number of the received data packets is equal to the current packet loss detection threshold, the packet loss detection on the current data block is triggered.

In the packet loss detection, the first received data packets may be recorded, and then, in combination with all data packets of the current data block, a comparison may be made to determine the first not-arrived data packets of the current data block.

In some implementations, the above S13 comprises:
(1) counting the number of the first received data packets of the current data block to determine a number of the first not-arrived data packets of the current data block;
(2) when the number of the first not-arrived data packets reaches the current packet loss detection threshold, determining the first not-arrived data packets of the current data block based on identifications of respective data packets of the current data block and identifications of the first received data packets.

Taking the data block as a unit, a counter is started, which has an initial value of 0. Each time one packet is received, the counter has its value added by 1. The value of the counter is used for representing the number of the first received data packets, and then by subtracting the number of the first received data packets from a total number of data packets of the current data block, the number of the first not-arrived data packets is obtained.

Each time the value of the counter is updated, the number of the first not-arrived data packets is calculated, or the number of the first not-arrived data packets is calculated every a preset time. When the number of the first not-arrived data packets reaches the packet loss detection threshold, it is indicated that the occasion of the packet loss detection is satisfied at this time, and the packet loss detection is performed. When at least one data packet is encapsulated into the current data block, in order to determine a data block to which each data packet belongs, the data packet is provided with an identification of the data block to which it belongs and its position in the current data block, which are hereinafter referred to as an identification of the data packet. Based on this, identifications of the first received data packets are extracted, and these identifications are compared with the identifications of respective data packets to determine identifications of the first not-arrived data packets of the current data block, so as to learn the first not-arrived data packets.

A packet loss detection threshold is the occasion of triggering the packet loss detection, and is obtained by counting the number of received data packets and determining the number of not-arrived data packets; and when the number of the not-arrived data packets is obtained, the first not-arrived data packets can be accurately determined by using the identifications of respective data packets.
S14, obtaining the first not-arrived data packets to obtain the data packets of the current data block.

In order to obtain the first not-arrived data packets, it is possible to trigger retransmission of the first not-arrived data packets; and of course, a reason for not arriving of the first not-arrived data packets may be that it has just been sent by a sender but has not yet arrived, or packet loss. Therefore, in order to obtain the first not-arrived data packets, it is possible to perform retransmission or wait for a period of time; or perform a combination of retransmission and waiting for a period of time; and so on. There is no limitation on it herein, and it is specifically set according to actual requirements.

For the packet loss detection of the current data block, it is possible to perform detection once, or perform rounds of detection. For example, in a data packet transmission process of the current data block, each time the data packet is received, the current packet loss detection threshold is dynamically updated in combination with the number of the received data packets of the current data block; and by setting a packet loss detection threshold, when the updated current packet loss detection threshold is greater than the packet loss detection threshold, a new round of packet loss detection is started until all the data packets arrive.

In the data transmission method provided in this embodiment, transmission and packet loss determination are performed by using a data block as a unit; because a data block can be delivered in its entirety to an application layer and the data blocks can be interacted independently of each other, the packet loss of the data block can be found as early as possible, avoiding that the data block is continually blocked by a lost packet; and in packet loss detection, by using the data packet as a driving time, it is determined whether the packet loss occurs and the first not-arrived data packets are obtained in time, without waiting for a timeout trigger or an acknowledge message, which enables less packet loss recovery time and data block transmission time, so that this method can be applied to a service having a time limit requirement for data block transmission, such as short video, live streaming, or the like.

In this embodiment, a data transmission method is provided, which may be used in an electronic device, such as a mobile terminal, a computer, or the like; FIG. 2 is a flow diagram of a data transmission method according to some embodiments of the present disclosure, as shown in FIG. 2, comprising the following steps:
S21, obtaining a size of a current data block and a historical packet loss rate of a historical data block.

The current data block comprises at least one data packet.

Please refer to the S11 of the embodiment shown in FIG. 1 for details, which will not be repeated herein.

S22, determining a current packet loss detection threshold for the current data block based on the size of the current data block and the historical packet loss rate.

Please refer to the S12 of the embodiment shown in FIG. 1 for details, which will not be repeated herein.

S23, when determining, based on a number of first received data packets of the current data block, that the current packet loss detection threshold is satisfied, performing packet loss detection on the current data block to determine a first not-arrived data packets of the current data block.

Please refer to the S13 of the embodiment shown in FIG. 1 for details, which will not be repeated herein.

S24, obtaining the first not-arrived data packets to obtain the data packets of the current data block.

In some embodiments, the above S24 comprises:
S241, obtaining sending times of the first not-arrived data packets and a current time, and determining flight times of the first not-arrived data packets.

By performing data communication with a sender, times of sending respective data packets by the sender can be learned, thereby obtaining the sending times of the first not-arrived data packets. Then, differences between the current time and the sending times are calculated to determine the flight times of respective first not-arrived data packets.

S242, determining a manner of obtaining the first not-arrived data packets based on a magnitude relation between the flight times and a flight time threshold, and obtaining the first not-arrived data packets in the manner of obtaining the first not-arrived data packets to obtain the data packets of the current data block.

Due to fluctuation of the network state, there may be an error in the calculation of the packet loss rate of the data block, resulting in repeatedly sending the data packet by the data packet-driven packet loss detection and retransmission mechanism, that is, excessive retransmission. Based on this, in this embodiment, the excessive retransmission is reduced or avoided by using the flight time threshold. The flight time threshold is set according to actual requirements, without any limitation on a specific value thereof herein.

In some implementations, the flight time threshold is determined based on a current service type. For a first service with a requirement for delay in seconds, such as live streaming, a flight time threshold is set to be small, for example, 20 ms; for a second service with some cache, such as short video, a flight time threshold is greater than the flight time threshold of the first service, for example, 200 ms; and for a third service with little requirement for delay, such as file download, a flight time threshold is greater than the flight time threshold of the second service, for example, it completely returns to the timeout-triggered retransmission mechanism, i.e., the flight time threshold is equal to a retransmission timeout time.

In other implementations, the flight time threshold is determined by: obtaining an excessive retransmission coefficient of the historical data blocks to determine the flight time threshold, the flight time threshold being in positive correlation with the excessive retransmission coefficient, and the excessive retransmission coefficient being used for representing a proportion of repeatedly received same retransmitted data packets in the historical data block.

Specifically, the excessive retransmission coefficient represents the proportion of repeatedly received packets in retransmitted packets, and the lower excessive retransmission coefficient, a smaller flight time threshold may be used; and the higher excessive retransmission coefficient, the larger flight time threshold needs to be adjusted, to reduce or avoid cost overhead caused by the excessive retransmission. For example, a size of the excessive retransmission coefficient is determined as the excessive retransmission coefficient; or, on the basis of a size of the excessive retransmission coefficient, the size multiplied by a preset value is determined as the excessive retransmission coefficient.

When the flight time is greater than the flight time threshold, it is indicated that the first not-arrived data packets is lost and there is a need for retransmission; and if the flight time is less than the flight time threshold, it is indicated that the first not-arrived data packets has just been sent by the sender and has not yet arrived and there is a need for wait.

The transmission performance and cost can be balanced by using the flight time threshold, to satisfy requirements of different services; the flight time threshold can be set to be a smaller value to achieve high performance, or to be a larger value to reduce or avoid excessive retransmission, and even returns to the timeout-triggered retransmission mechanism.

In some implementations, the above S242 comprises:
(1) screening out, among the first not-arrived data packets, a second not-arrived data packet with a flight time greater than the flight time threshold and a third not-arrived data packet with a flight time less than the flight time threshold.

The first not-arrived data packets are classified by using the magnitude relation between the flight time and the flight time threshold, to obtain the second not-arrived data packet to be retransmitted and the third not-arrived data packet to wait.
(2) Triggering retransmission of the second not-arrived data packet.

An identification of the second not-arrived data packet is notified to the sender, and accordingly, the sender determines a data packet to be retransmitted by using the identification, thereby realizing the retransmission of the second not-arrived data packet.

In some implementations, the above step (2) comprises:
2.1) obtaining packet loss rates of respective transmission paths;
2.2) retransmitting the second not-arrived data packet based on a transmission path with a lowest packet loss rate.

Transmission between the sender and the receiver can be performed by using a plurality of transmission paths, then, when retransmission of the data packet is needed, the transmission path with the lowest packet loss rate is selected for retransmission of the second not-arrived data packet by using the packet loss rates of respective transmission paths, to reduce a loss probability of the retransmitted data packet.

Based on the packet loss rate of each transmission path, the transmission path with the lowest probability is selected for retransmission, to reduce or avoid that the retransmitted data packet is lost and then retransmission is performed many times.
(3) Reducing a retransmission timeout time of the third not-arrived data packet, and obtaining the third not-arrived data packet based on the reduced retransmission timeout time.

As described above, the third not-arrived data packet represents that the data packet has just been sent from the sender, then the retransmission timeout time (RTO) of the data packet is updated, to shorten a timeout trigger time. For shortening of the retransmission timeout time of the third not-arrived data packet, a preset value can be directly subtracted on the basis of the retransmission timeout time to obtain a reduced retransmission timeout time; or, the retransmission timeout time is re-calculated according to a preset calculation formula, or the like. There is no limitation on the specific manner of reducing the retransmission timeout time herein, and it is specifically set according to actual requirements, simply ensuring that the retransmission timeout time of the third not-arrived data packet is reduced.

In some implementations, the above step (3) comprises:
3.1) obtaining a current bandwidth utilization rate and a round trip time for a single connection;
3.2) calculating a difference between the retransmission timeout time and the round trip time for the single connection, and calculating a product of the difference and the current bandwidth utilization rate;
3.3) determining the reduced retransmission timeout time based on a sum of the product and the round trip time for the single connection.

In some embodiments, the reduced retransmission timeout time Tail RTO is calculated by using the following formula:

$$Tail\_RTO = ( RTO - RTT ) * sessionrate + RTT$$

where RTO is the retransmission timeout time, RTT is the round trip time for the single connection, sessionrate is the current bandwidth utilization rate, with a value between 0 and 1, and the lower the bandwidth utilization rate sessionrate, the smaller the Tail_RTO, the more quickly the timeout retransmission is triggered.

The estimation of the retransmission timeout time in combination with the current bandwidth utilization rate and the round trip time for the single connection, can ensure the reliability of the reduced retransmission timeout time.

In the data packet-driven packet loss detection and retransmission, when a detection condition is satisfied, a data packet which does not arrive in time and has a flight time beyond the flight time threshold is immediately retransmitted, which can find loss of the data packet earlier and reduce the transmission time for the data block; and for a data packet which does not arrive in time but has a flight time less than the flight time threshold, the retransmission timeout time is adjusted to shorten a timeout trigger condition.

In the data transmission method provided in this embodiment, due to fluctuation of the network state, there may be an error in estimation of the packet loss rate of the data block, resulting in repeatedly sending data by the data packet-driven packet loss detection and retransmission mechanism, that is, excessive retransmission. Based on this, constraint is made by using the flight time threshold to reduce or avoid the excessive retransmission.

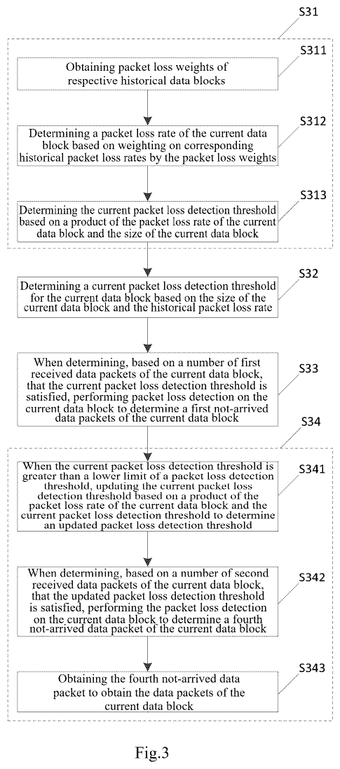

In this embodiment, a data transmission method is provided, which can be used in an electronic device, such as a mobile terminal, a computer, or the like; FIG. 3 is a flow diagram of a data transmission method according to some embodiments of the present disclosure, as shown in FIG. 3, comprising the following steps:
S31, obtaining a size of a current data block and a historical packet loss rate of a historical data block.

The current data block comprises at least one data packet, and the historical data block comprises at least two data blocks.

In some embodiments, the above S31 comprises:
S311, obtaining packet loss weights of respective historical data blocks.

The number of the historical data blocks is set according to actual requirements, for example, latest N data blocks are taken as N historical data blocks. And the packet loss weight of the historical data block declines over time, that is, the closer a completion time of the historical data block is to the current time, the greater the packet loss weight of the historical data block is, to ensure that a subsequently determined packet loss rate of the current data block is consistent with a latest network state.
S312, determining a packet loss rate of the current data block based on weighting on corresponding historical packet loss rates by the packet loss weights.

In a transmission process of the data packet, after downloading of each data block is completed, the packet loss rate of the data block is counted, wherein the historical packet loss rate 1, of the historical data block i is calculated by using the following formula:

$${l}_{i} = ( send\_data {\_size}_{i} - recv\_data {\_size}_{i} ) / send\_data {\_size}_{i} * 100 \%$$

where send_data_sizeᵢ is the number of sent data packets of a historical data block i, recv_data_sizeᵢ is the number of received data packets of the historical data block i.

Further, the packet loss rate of the current data block is calculated by using the following formula:

$$loss = {\sum }_{i} {ω}_{i} * {l}_{i} .$$

S313, determining the current packet loss detection threshold based on a product of the packet loss rate of the current data block and the size of the current data block.

As described above, for each data block, a counter C and a packet loss detection threshold P are maintained, where C represents a number of currently-arrived data packets and P represents a threshold for a number of not-arrived data packets. Each time the data packet is received, it is determined whether a number of remaining not-arrived data packets is less than or equal to P, and if it is less than or equal to P, the packet loss detection is performed.

When the data block starts to be transmitted and each time the packet loss detection is triggered, P is re-calculated until P is zero or all the data packets arrive. In the data packet transmission process of the current data block, the packet loss detection threshold P is decreased progressively, and the effect of packet loss detection many times can be achieved in this way.

After the packet loss rate of the current data block is calculated, the product of the packet loss rate of the current data block and the size of the current data block is calculated to determine the current packet loss detection threshold P.

In some implementations, if a number of lost packets of the current data block is less than the packet loss detection threshold P, redundant data may be repeatedly injected, and based on this, redundancy is controlled by using the flight time threshold in the above-described embodiment.

If a number of lost packets of the current data block is greater than the packet loss detection threshold P, the packet loss detection may not be triggered for a long time, and at this time, for remaining not-arrived data packets, it will return to the RTO-triggered retransmission mechanism. For this case, a timeout time is added to ensure that packet loss detection can also be triggered in this case. Specifically, in the process of receiving the data packets of the current data block, a flight time of a received data packet is recorded, the flight time is compared with the timeout time, and if it is greater than the timeout time, the packet loss detection is also triggered.
S32, determining a current packet loss detection threshold for the current data block based on the size of the current data block and the historical packet loss rate.

Please refer to the S12 of the embodiment shown in FIG. 1 for details, which will not be repeated herein.
S33, when determining, based on a number of first received data packets of the current data block, that the current packet loss detection threshold is satisfied, performing packet loss detection on the current data block to determine a first not-arrived data packets of the current data block.

Please refer to the S13 of the embodiment shown in FIG. 1 for details, which will not be repeated herein.
S34, obtaining the first not-arrived data packets to obtain the data packets of the current data block.

In some embodiments, the above S34 comprises:
S341, when the current packet loss detection threshold is greater than a lower limit of a packet loss detection threshold, updating the current packet loss detection threshold based on a product of the packet loss rate of the current data block and the current packet loss detection threshold to determine an updated packet loss detection threshold.

The lower limit of the packet loss detection threshold is set to trigger a plurality of rounds of packet loss detection. When the current packet loss detection threshold is greater than the lower limit of the packet loss detection threshold, it is indicated that packet loss detection needs to be performed again. On one hand, the obtaining of the first not-arrived data packets based on the current packet loss detection threshold is triggered; on the other hand, the current packet loss detection threshold is updated based on the product of the packet loss rate of the current data block and the current packet loss detection threshold, to obtain the updated packet loss detection threshold, and then the packet loss detection is performed by using the updated packet loss detection threshold.
S342, when determining, based on a number of second received data packets of the current data block, that the updated packet loss detection threshold is satisfied, performing the packet loss detection on the current data block to determine a fourth not-arrived data packet of the current data block.

After the processing of the above first aspect, a new data packet is obtained, and the received data packet here is referred to as the second received data packet. The number of the second received data packet is counted, and remaining not-arrived data packets are calculated. When a number of the remaining not-arrived data packets satisfies the updated packet loss detection threshold, the fourth not-arrived data packet of the current data block is determined. The manner of determining the fourth not-arrived data packet is similar to the manner of determining the first not-arrived data packets, and will not be repeated herein.
S343, obtaining the fourth not-arrived data packet to obtain the data packets of the current data block.

The manner of obtaining the fourth not-arrived data packet is similar to the manner of obtaining the first not-arrived data packets, both being that, by combining the flight time threshold, the not-arrived data packets are divided into not-arrived data packets to be retransmitted and not-arrived data packets to wait. For the not-arrived data packets to be retransmitted, retransmission is triggered, and for the not-arrived data packets to wait, an RTO of the not-arrived data packets is reduced, and then retransmission detection is performed based on the reduced RTO.

In the data transmission method provided in this embodiment, the historical packet loss rates of at least two historical data blocks before the current data block are weighted, so that the packet loss rate of the current data block is obtained by fusing the historical packet loss rates of the at least two historical data blocks, and further in combination with the size of the current data block, a more accurate current packet loss detection threshold can be obtained. For a retransmitted data packet, there may be packet loss with a certain probability, and based on this, a plurality of rounds of packet loss detection are performed to find a lost packet as early as possible and retransmit it.

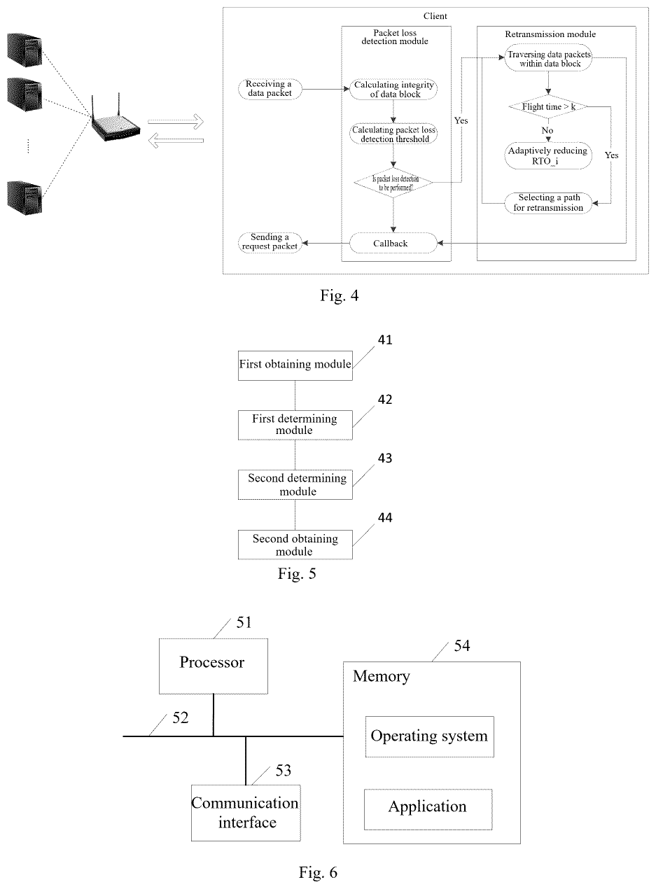

As a specific application example of some embodiments of the present disclosure, as shown in FIG. 4, data transmission is made between a client and a sender through a plurality of transmission paths. In this embodiment, a data block is a video frame, that is, one video frame is divided into at least one data packet for transmission, and each data packet has therein recorded an identification indicating a video frame to which the data block belongs and a position of the data packet in the video frame. After receiving the data packet, the client sends it into a packet loss detection module for packet loss detection. That is, firstly, a number of the received data packets is counted, integrity detection is performed on the current data block, and a current packet loss threshold is calculated. When a number of not-arrived data packets is less than or equal to the current packet loss threshold, the packet loss detection is triggered. The not-arrived data packets are determined based on identifications of the received data packets, and then flight times of the not-arrived data packets are compared with a flight time threshold k, respectively, if it is greater than the flight time threshold k, a transmission path is selected for retransmission; and if it is less than or equal to the flight time threshold, an RTO of the not-arrived data packet is reduced, and retransmission detection is performed by using the reduced RTO. The detection results of the above packet loss detection module and retransmission module are formed into a sending request packet based on a callback function, and the sending request packet is sent to the sender, so that the sender performs corresponding processing based on the sending request packet.

In downloading of a task, the client establishes connections with a plurality of servers deployed with related file resources, and then sends a data downloading request to the servers, that is, data in a request queue is requested to the servers in a polling mode by default. The servers issue corresponding data packets based on the request, and the client receives and integrates the data packets transmitted in transmission paths, and when the data block is integral, delivers it to an application layer. The client dynamically calculates a packet loss detection threshold Pⱼ of a j-th round of packet loss detection, and each time a data packet is received, determination as to whether a number of not-arrived data blocks satisfies the packet loss detection threshold is triggered. If the number of the not-arrived data block satisfies the packet loss detection threshold, the packet loss detection is performed, and the packet loss detection threshold is updated to Pⱼ₊₁ and a next round of detection is started until all the data blocks arrive. If the packet loss detection logic is entered, the receiver generates a list of the not-arrived data packets according to the cached data block, sequentially calculates a flight time of each not-arrived data packet, if the flight time exceeds the flight time threshold, it is determined that the data packet is lost, and the data packet is retransmitted immediately, otherwise, the RTO is adaptively reduced.

As a specific application example of some embodiments of the present disclosure, the packet loss detection once is taken as an example. Data blocks 1, 2 and 3 are sequentially transmitted by using two transmission paths, a data block size is 512 KB, the packet loss rates of the transmission of the data blocks 1 and 2 are 1% and 2%, respectively, and a packet loss detection threshold P0 for the data block 3 is calculated by using the packet loss rate of the data block 2. That is, P0=512*2%=10, and based on this, for the data block 3, when a 502-th (i.e., 512−10=502) data packet is received, retransmission detection is triggered. By the packet loss detection logic, it is determined that not-arrived data packets in packet loss detection are numbered: 10, 11, 12, 77, 78, 79, 80, 509, 510, 511, and flight times of these not-arrived data packets are 200 ms, 200 ms, 201 ms, 150 ms, 150 ms, 151 ms, 151 ms, 5 ms, 5 ms, 4 ms, respectively. If a flight time threshold is 150 ms, the flight time of each not-arrived data packet is compared with the flight time threshold, and not-arrived data packets to be retransmitted are numbered: 10, 11, 12, 77, 78, 79, 80; and not-arrived data packets that need adaptively reduced RTO are numbered: 509, 510, 511.

As another specific application example of some embodiments of the present disclosure, data blocks 1, 2, and 3 are sequentially transmitted by using two transmission paths, a data block size is 512 KB, packet loss rates of the transmission of the data blocks 1 and 2 are 10% and 15%, respectively, and by using the packet loss rate of the data block 2, a packet loss detection threshold for a first round of packet loss detection of the data block is calculated. That is, P0=512*15%=76. In this embodiment, a lower limit of a packet loss detection threshold is 1, and since P0>0, a second round of packet loss detection is needed, for which a packet loss detection threshold is: P 1=P0*15%=76*15%=11; similarly, since P1>0, a third round of packet loss detection is needed, for which a packet loss detection threshold is: P2−P1*15%=11*15%=2. Since in a fourth round of packet loss detection, a packet loss detection threshold is calculated by: P3=P2*15%=2*15%=0.3, which is less than 1, it is indicated that three rounds of packet loss retransmission detection are needed in total.

Since P0=76, P1=11, and P2=2, when 436-th, 501-th, and 510-th data packets are received, respectively, retransmission detection is triggered for the data block, then not-arrived data packets in the first round of packet loss detection are numbered: 51-56, 201-230, 472-511; not-arrived data packets in the second round of packet loss detection are numbered: 223-231, 473, 501, and not-arrived data packets in the third round of packet loss detection are numbered 231, 473.

In the first round of packet loss detection, there are the not-arrived data packets 51-56, 201-230, 472-511, wherein the flight time of the not-arrived data packets 51-56 is 400+ms, the flight time of the not-arrived data packets 201-230 is 200+ms, and the flight time of the not-arrived data packets 472-511 is 10+ms. A flight time threshold is 150 ms, then the not-arrived data packets 51-56 and the not-arrived data packet 201-230 need to be retransmitted, and RTOs of the not-arrived data packets 472-511 need to be adaptively reduced.

In the second round of packet loss detection, there are the not-arrived data packets 223-231, 473, 501, of which the flight time is 200+ms, then the not-arrived data packets 223-231, 473, 501 all need to be retransmitted.

In the third round of packet loss detection, there are the not-arrived data packets 231 and 473, of which the flight times are 250 ms and 360 ms, and since the flight times are greater than the flight time threshold of 150 ms, the not-arrived data packets 231 and 473 both need to be retransmitted.

As another specific application example of some embodiments of the present disclosure, data blocks 1, 2, and 3 are sequentially transmitted by using two transmission paths, a data block size is 512 KB, packet loss rates of the transmission of the data blocks 1 and 2 are 0% and 0%, respectively, and a packet loss detection threshold for the data block 3 is calculated by using the packet loss rate of the data block 2, that is, P0=512*0%=0. Based on this, the packet loss detection retransmission is not triggered in the transmission process of the data block 3, so that it returns to the timeout-triggered retransmission mechanism.

As another specific application example of some embodiments of the present disclosure, data blocks 1, 2, and 3 are sequentially transmitted by using two transmission paths, a data block size is 100 KB, packet loss rates of the transmission of the data blocks 1 and 2 are 5% and 5%, respectively, and a packet loss detection threshold for the data block is calculated by using the packet loss rate of the data block 2, that is, P0=100*5%=5, then, when a 95-th data packet is received, the retransmission detection is triggered for the data block 3. By packet loss detection, it is determined that not-arrived data packets are numbered 10, 15-17 and 40, and have the flight times of 300 ms, 280 ms, 281 ms, 282 ms and 220 ms, respectively. A flight time threshold is 150 ms, then the not-arrived data packets 10, 15-17, 40 all need to be retransmitted.

In this embodiment, a data transmission apparatus is further provided, for implementing the above embodiments and preferred implementations, which have already been described and will not be repeated. As used below, the term “module” may be a combination of software and/or hardware that implements a predetermined function. Although the apparatus described in the embodiments below are preferably implemented in software, an implementation in hardware or a combination of software and hardware is also possible and contemplated.

This embodiment provides a data transmission apparatus, as shown in FIG. 5, comprising:
a first obtaining module 41 configured to obtain a size of a current data block and a historical packet loss rate of a historical data block, the current data block comprising at least one data packet;
a first determining module 42 configured to determine a current packet loss detection threshold for the current data block based on the size of the current data block and the historical packet loss rate;
a second determining module 43 configured to when determining, based on a number of first received data packets of the current data block, that the current packet loss detection threshold is satisfied, perform packet loss detection on the current data block to determine a first not-arrived data packets of the current data block; and
a second obtaining module 44 configured to obtain the first not-arrived data packets to obtain the data packets of the current data block.

In some implementations, the historical data block comprises at least two data blocks, and the first determining module 42 comprises:
a first obtaining unit configured to packet loss weights of respective historical data blocks;
a first determining unit configured to determine a packet loss rate of the current data block based on weighting on corresponding historical packet loss rates by the packet loss weights; and
a second determining unit configured to determine the current packet loss detection threshold based on a product of the packet loss rate of the current data block and the size of the current data block.

In some implementations, the second determining module 43 comprises:
a counting unit configured to count the number of the first received data packets of the current data block to determine a number of the first not-arrived data packets of the current data block; and
a third determining unit configured to when the number of the first not-arrived data packets reaches the current packet loss detection threshold, determine the first not-arrived data packets of the current data block based on identifications of respective data packets of the current data block and identifications of the first received data packets.

In some implementations, the second obtaining module 44 comprises:
a second obtaining unit configured to obtain sending times of the first not-arrived data packets and a current time, and determining flight times of the first not-arrived data packets; and
a fourth determining unit configured to determine a manner of obtaining the first not-arrived data packets based on a magnitude relation between the flight times and a flight time threshold, and obtain the first not-arrived data packets in the manner of obtaining the first not-arrived data packets to obtain the data packets of the current data block.

In some implementations, the fourth determining unit comprises:
a screening subunit configured to screen out, among the first not-arrived data packets, a second not-arrived data packet with a flight time greater than the flight time threshold and a third not-arrived data packet with a flight time less than the flight time threshold;
a triggering subunit configured to trigger retransmission of the second not-arrived data packet; and
a reducing subunit configured to reduce a retransmission timeout time of the third not-arrived data packet, and obtain the third not-arrived data packet based on the reduced retransmission timeout time.

In some implementations, a determining module for the flight time threshold comprises:
a fifth determining unit configured to determine the flight time threshold based on a current service type; or,
a sixth determining unit configured to obtain an excessive retransmission coefficient of the historical data block to determine the flight time threshold, the flight time threshold being in positive correlation with the excessive retransmission coefficient, and the excessive retransmission coefficient being used for representing a proportion of repeatedly received same retransmitted data packets in the historical data block.

In some implementations, the triggering subunit comprises:
a first obtaining subunit configured to obtain packet loss rates of respective transmission paths; and
a retransmitting subunit configured to retransmit the second not-arrived data packet based on a transmission path with a lowest packet loss rate.

In some implementations, the reducing subunit comprises:
a second obtaining subunit configured to obtain a current bandwidth utilization rate and a round trip time for a single connection;
a calculating subunit configured to calculate a difference between the retransmission timeout time and the round trip time for the single connection, and calculate a product of the difference and the current bandwidth utilization rate; and
a determining subunit configured to determine the reduced retransmission timeout time based on a sum of the product and the round trip time for the single connection.

In some implementations, the second obtaining module 44 further comprises:
an updating unit configured to when the current packet loss detection threshold is greater than a lower limit of a packet loss detection threshold, update the current packet loss detection threshold based on a product of the packet loss rate of the current data block and the current packet loss detection threshold to determine an updated packet loss detection threshold;
a packet loss detecting unit configured to when determine, based on a number of second received data packets of the current data block, that the updated packet loss detection threshold is satisfied, performing the packet loss detection on the current data block to determine a fourth not-arrived data packet of the current data block; and
a third obtaining unit configured to obtain the fourth not-arrived data packet to obtain the data packets of the current data block.

The data transmission apparatus in this embodiment is presented in a form of functional units, wherein the units refer to an ASIC circuit, a processor executing one or more software or fixed programs, a memory, and/or other devices that may provide the above functions.

Further functional descriptions of the modules described above are the same as those of the corresponding embodiments described above, which are not be repeated herein.

Some embodiments of the present disclosure further provide an electronic device having the data transmission apparatus shown in FIG. 5.

Referring to FIG. 6, FIG. 6 is a schematic structural diagram of an electronic device according to an optional embodiment of the present disclosure, and as shown in FIG. 6, the electronic device may comprise: at least one processor 51, such as a CPU (Central Processing Unit), at least one communication interface 53, a memory 54, at least one communication bus 52. The communication bus 52 is used for connection and communication between these components. The communication interface 53 may include a display and a keyboard, and optionally, the communication interface 53 may also include a standard wired interface and a standard wireless interface. The memory 54 may be a high-speed RAM (Random Access Memory, volatile random access memory) or a non-volatile memory, such as at least one disk memory. The memory 54 may optionally be at least one storage device located remotely from the above processor 51. The processor 51 may be combined with the apparatus described in FIG. 5, the memory 54 has an application stored therein, and the processor 51 calls program code stored in the memory 54 for performing the steps of any of the above methods.

The communication bus 52 may be a peripheral component interconnect (PCI for short) bus, an extended industry standard architecture (EISA for short) bus, or the like. The communication bus 52 may be divided into an address bus, a data bus, a control bus, or the like. For ease of illustration, only one thick line is used in FIG. 6, but it is not indicated that there is only one bus or one type of bus.

The memory 54 may include a volatile memory, such as a random-access memory (RAM); the memory may also include a non-volatile memory, such as a flash memory, a hard disk drive (HDD) or a solid-state drive (SSD); and the memory 54 may also include a combination of the above types of memories.

The processor 51 may be a central processing unit (CPU), a network processor (NP), or a combination of the CPU and NP.

The processor 51 may further include a hardware chip. The above hardware chip may be an application-specific integrated circuit (ASIC), a programmable logic device (PLD), or a combination thereof. The above PLD may be a complex programmable logic device (CPLD), a field-programmable gate array (FPGA), a generic array logic (GAL), or any combination thereof.

Optionally, the memory 54 is also configured to store program instructions. The processor 51 may call the program instructions to implement the data transmission method illustrated in any of the embodiments of the present application.

Some embodiments of the present disclosure also provide a non-transitory computer storage medium having thereon stored computer-executable instructions that may perform the data transmission method in any of the method embodiments described above. The storage medium may be a magnetic disk, an optical Disk, a read-only memory (ROM), a random access memory (RAM), a flash memory, a hard disk drive (HDD), or a solid-state drive (SSD); and the storage medium may also include a combination of the above types of memories.

Some embodiments of the disclosure also provide a computer program or a computer program product, comprising computer-executable instructions that may perform the data transmission method in any of the above method embodiments.

The embodiments in this description are all described in a progressive manner, and same and similar parts among the embodiments are referred to each other, and each embodiment focuses on differences from other embodiments. In particular, as for the method embodiments, since they are substantially similar to the apparatus and system embodiments, the description is relatively simple, and reference may be made to the description of the apparatus and system embodiments for relevant points.

It can be understood that in the specific implementations of the present disclosure, related data such as data blocks is involved, so that when the above embodiments of the present disclosure are applied to a specific product or technology, user permission or consent needs to be obtained, and the collection, use and processing of the related data need to comply with related laws and regulations and standards in related countries and regions.

Although the embodiments of the present disclosure have been described in conjunction with the accompanying drawings, those skilled in the art may make various modifications and variations without departing from the spirit and scope of the present disclosure, and such modifications and variations all fall within the scope defined by the appended claims.

1. A data transmission method, comprising:
obtaining a size of a current data block and a historical packet loss rate of a historical data block, the current data block comprising at least one data packet;
determining a current packet loss detection threshold for the current data block based on the size of the current data block and the historical packet loss rate;
in response to determining, based on a number of first received data packets of the current data block, that the current packet loss detection threshold is satisfied, performing packet loss detection on the current data block to determine a first not-arrived data packets of the current data block; and
obtaining the first not-arrived data packets to obtain the data packets of the current data block.

2. The method according to claim 1, wherein the historical data block comprises at least two data blocks, and the determining a current packet loss detection threshold for the current data block based on the size of the current data block and the historical packet loss rate comprises:
obtaining packet loss weights of respective historical data blocks;
determining a packet loss rate of the current data block based on weighting on corresponding historical packet loss rates by the packet loss weights; and
determining the current packet loss detection threshold based on a product of the packet loss rate of the current data block and the size of the current data block.

3. The method according to claim 1, wherein the in response to determining, based on a number of first received data packets of the current data block, that the current packet loss detection threshold is satisfied, performing packet loss detection on the current data block to determine a first not-arrived data packets of the current data block comprises:
counting the number of the first received data packets of the current data block to determine a number of the first not-arrived data packets of the current data block; and
in response to the number of the first not-arrived data packets being less than or equal to the current packet loss detection threshold, determining the first not-arrived data packets of the current data block based on identifications of respective data packets of the current data block and identifications of the first received data packets.

4. The method according to claim 1, wherein the obtaining the first not-arrived data packets to obtain the data packets of the current data block comprises:
obtaining sending times of the first not-arrived data packets and a current time, and determining flight times of the first not-arrived data packets; and
determining a manner of obtaining the first not-arrived data packets based on a magnitude relation between the flight times and a flight time threshold, and obtaining the first not-arrived data packets in the manner of obtaining the first not-arrived data packets to obtain the data packets of the current data block.

5. The method according to claim 4, wherein the determining a manner of obtaining the first not-arrived data packets based on a magnitude relation between the flight times and a flight time threshold, and obtaining the first not-arrived data packets in the manner of obtaining the first not-arrived data packets to obtain the data packets of the current data block comprises:
screening out, among the first not-arrived data packets, a second not-arrived data packet with a flight time greater than the flight time threshold and a third not-arrived data packet with a flight time less than the flight time threshold;
triggering retransmission of the second not-arrived data packet; and
reducing a retransmission timeout time of the third not-arrived data packet, and obtaining the third not-arrived data packet based on the reduced retransmission timeout time.

6. The method according to claim 5, wherein a manner for determining the flight time threshold comprises:
determining the flight time threshold based on a current service type; or,
obtaining an excessive retransmission coefficient of the historical data block to determine the flight time threshold, the flight time threshold being in positive correlation with the excessive retransmission coefficient, and the excessive retransmission coefficient being used for representing a proportion of repeatedly received same retransmitted data packets in the historical data block.

7. The method according to claim 5, wherein the triggering retransmission of the second not-arrived data packet comprises:
obtaining packet loss rates of respective transmission paths; and
retransmitting the second not-arrived data packet based on a transmission path with a lowest packet loss rate.

8. The method according to claim 5, wherein the reducing a retransmission timeout time of the third not-arrived data packet comprises:
obtaining a current bandwidth utilization rate and a round trip time for a single connection;
calculating a difference between the retransmission timeout time and the round trip time for the single connection, and calculating a product of the difference and the current bandwidth utilization rate; and
determining the reduced retransmission timeout time based on a sum of the product and the round trip time for the single connection.

9. The method according to claim 2, wherein the obtaining the first not-arrived data packets to obtain the data packets of the current data block further comprises:
in response to the current packet loss detection threshold being greater than a lower limit of a packet loss detection threshold, updating the current packet loss detection threshold based on a product of the packet loss rate of the current data block and the current packet loss detection threshold to determine an updated packet loss detection threshold;
in response to determining, based on a number of second received data packets of the current data block, that the updated packet loss detection threshold is satisfied, performing the packet loss detection on the current data block to determine a fourth not-arrived data packet of the current data block; and
obtaining the fourth not-arrived data packet to obtain the data packets of the current data block.

10. (canceled)

11. An electronic device, comprising:
a memory and a processor, wherein the memory and the processor is communicatively connected with one another, the memory has computer instructions stored therein, and the processor, by executing the computer instructions, performs the following data transmission operations:
obtaining a size of a current data block and a historical packet loss rate of a historical data block, the current data block comprising at least one data packet;
determining a current packet loss detection threshold for the current data block based on the size of the current data block and the historical packet loss rate;
in response to determining, based on a number of first received data packets of the current data block, that the current packet loss detection threshold is satisfied, performing packet loss detection on the current data block to determine a first not-arrived data packets of the current data block; and
obtaining the first not-arrived data packets to obtain the data packets of the current data block.

12. A non-transitory computer-readable storage medium having stored thereon computer instructions for causing a computer to perform the following data transmission operations:
obtaining a size of a current data block and a historical packet loss rate of a historical data block, the current data block comprising at least one data packet;
determining a current packet loss detection threshold for the current data block based on the size of the current data block and the historical packet loss rate;
in response to determining, based on a number of first received data packets of the current data block, that the current packet loss detection threshold is satisfied, performing packet loss detection on the current data block to determine a first not-arrived data packets of the current data block; and
obtaining the first not-arrived data packets to obtain the data packets of the current data block.

13. The electronic device according to claim 11, wherein the historical data block comprises at least two data blocks, and the determining a current packet loss detection threshold for the current data block based on the size of the current data block and the historical packet loss rate comprises:
obtaining packet loss weights of respective historical data blocks;
determining a packet loss rate of the current data block based on weighting on corresponding historical packet loss rates by the packet loss weights; and
determining the current packet loss detection threshold based on a product of the packet loss rate of the current data block and the size of the current data block.

14. The electronic device according to claim 11, wherein the in response to determining, based on a number of first received data packets of the current data block, that the current packet loss detection threshold is satisfied, performing packet loss detection on the current data block to determine a first not-arrived data packets of the current data block comprises:
counting the number of the first received data packets of the current data block to determine a number of the first not-arrived data packets of the current data block; and
in response to the number of the first not-arrived data packets being less than or equal to the current packet loss detection threshold, determining the first not-arrived data packets of the current data block based on identifications of respective data packets of the current data block and identifications of the first received data packets.

15. The electronic device according to claim 11, wherein the obtaining the first not-arrived data packets to obtain the data packets of the current data block comprises:
obtaining sending times of the first not-arrived data packets and a current time, and determining flight times of the first not-arrived data packets; and
determining a manner of obtaining the first not-arrived data packets based on a magnitude relation between the flight times and a flight time threshold, and obtaining the first not-arrived data packets in the manner of obtaining the first not-arrived data packets to obtain the data packets of the current data block.

16. The electronic device according to claim 15, wherein the determining a manner of obtaining the first not-arrived data packets based on a magnitude relation between the flight times and a flight time threshold, and obtaining the first not-arrived data packets in the manner of obtaining the first not-arrived data packets to obtain the data packets of the current data block comprises:
screening out, among the first not-arrived data packets, a second not-arrived data packet with a flight time greater than the flight time threshold and a third not-arrived data packet with a flight time less than the flight time threshold;
triggering retransmission of the second not-arrived data packet; and
reducing a retransmission timeout time of the third not-arrived data packet, and obtaining the third not-arrived data packet based on the reduced retransmission timeout time.

17. The storage medium according to claim 12, wherein the historical data block comprises at least two data blocks, and the determining a current packet loss detection threshold for the current data block based on the size of the current data block and the historical packet loss rate comprises:
obtaining packet loss weights of respective historical data blocks;
determining a packet loss rate of the current data block based on weighting on corresponding historical packet loss rates by the packet loss weights; and
determining the current packet loss detection threshold based on a product of the packet loss rate of the current data block and the size of the current data block.

18. The storage medium according to claim 12, wherein the in response to determining, based on a number of first received data packets of the current data block, that the current packet loss detection threshold is satisfied, performing packet loss detection on the current data block to determine a first not-arrived data packets of the current data block comprises:
counting the number of the first received data packets of the current data block to determine a number of the first not-arrived data packets of the current data block; and
in response to the number of the first not-arrived data packets being less than or equal to the current packet loss detection threshold, determining the first not-arrived data packets of the current data block based on identifications of respective data packets of the current data block and identifications of the first received data packets.

19. The storage medium according to claim 12, wherein the obtaining the first not-arrived data packets to obtain the data packets of the current data block comprises:
obtaining sending times of the first not-arrived data packets and a current time, and determining flight times of the first not-arrived data packets; and
determining a manner of obtaining the first not-arrived data packets based on a magnitude relation between the flight times and a flight time threshold, and obtaining the first not-arrived data packets in the manner of obtaining the first not-arrived data packets to obtain the data packets of the current data block.

20. The storage medium according to claim 19, wherein the determining a manner of obtaining the first not-arrived data packets based on a magnitude relation between the flight times and a flight time threshold, and obtaining the first not-arrived data packets in the manner of obtaining the first not-arrived data packets to obtain the data packets of the current data block comprises:
screening out, among the first not-arrived data packets, a second not-arrived data packet with a flight time greater than the flight time threshold and a third not-arrived data packet with a flight time less than the flight time threshold;
triggering retransmission of the second not-arrived data packet; and
reducing a retransmission timeout time of the third not-arrived data packet, and obtaining the third not-arrived data packet based on the reduced retransmission timeout time.

21. The storage medium according to claim 20, wherein a manner for determining the flight time threshold comprises:
determining the flight time threshold based on a current service type; or,
obtaining an excessive retransmission coefficient of the historical data block to determine the flight time threshold, the flight time threshold being in positive correlation with the excessive retransmission coefficient, and the excessive retransmission coefficient being used for representing a proportion of repeatedly received same retransmitted data packets in the historical data block.
